(19) United States
(12) Patent Application Publication
(10) Pub. No.: US 2012/0136614 A1
(43) Pub. Date: May 31, 2012

(54) Wafer inspection system

(75) Inventors: Ta Kang Liu, Hsinchu (TW); Ming Hsien Lee, Hsinchu (TW)

(73) Assignee: King Yuan Electronics Co., Ltd., Hsinchu (TW)

(21) Appl. No.: 13/064,163

(22) Filed: Mar. 9, 2011

(30) Foreign Application Priority Data
Nov. 30, 2010 (TW) 099141449

(51) Int. Cl. G06F 19/00

(52) U.S. Cl. 702/122

(57) ABSTRACT

A wafer inspection system for inspecting a wafer comprises a platform, a probe card, a illuminator, a test server, at least one image processing device, a control circuit board, at least a test circuit board, a load board connected to the control circuit board and the at least a test circuit board, at least an image card, and at least a relay board. The probe card includes an opening hole and a plurality of probes for contacting the wafer to transmit and receive electrical signals. The illuminator illuminates on the wafer through the opening hole. The test server is controlled to execute test procedure and data process. The test circuit board transmits test signals and performs a determination on the received result signals. The relay board is connected to the probe card and the load board for switching the direction of data flow.

### BACKGROUND OF THE INVENTION

1. Field of the Invention

The present invention relates to a measurement device and, more particularly, to a wafer inspection system.

2. Description of Related Art

Generally, a test server is used for controlling test and processing test results in a conventional wafer inspection system. Please refer to FIG. 1, which is a schematic diagram of a conventional wafer inspection system. As shown in FIG. 1, the system comprises a platform 101, a probe card 102, an illuminator 103, a test server 104, a plurality of test circuit boards 105 and a plurality of processing devices 106. The probe card 102 includes an opening hole 1021 and a plurality of probes 1022. The test server 104 is connected to the platform 101, the illuminator 103 and the processing devices 106. The test circuit boards 105 are connected to the probe card 102 and the processing devices 106.

When inspecting, a wafer 9 is placed on the platform 101 and the probes 1022 of the probe card 102 are made to contact the wafer 9 directly. The illuminator 103 illuminates on the wafer 9 through the opening hole 1021 of the probe card 102. The test server 104 is controlled by users to execute related procedures of wafer inspection. At least a test circuit board 105 sends control commands to the probe card 102. The probe card 102 sends electrical signals to the wafer 9 through the probes and receives responded electrical signals from the wafer 9 to determine whether the wafer is in normal operation. The at least a test circuit board 105 transmits test results to the test server 104. The test server 104 performs a determination from the test results and sends image signals to at least a processing device 106 for processing.

As mentioned above, in the conventional wafer inspection method, the test server is provided for executing all of the test procedures, receiving test result signals, processing the received electrical signals and sending the received image signals to the processing devices. Since the execution efficiency and transmission speed of one single machine is limited, the execution efficiency and the transmission of test result signals of the conventional wafer inspection method are completely limited by hardware and the transmission speed of the test server, resulting in that the amount of dies inspected at the same time cannot be increased.

Therefore, it is desirable to provide a wafer inspection system to mitigate and/or obviate the aforementioned problems.

### SUMMARY OF THE INVENTION

The object of the present invention is to provide a wafer inspection system, which shunts test result signals by a relay board, so as to directly transmit image signals to the image processing devices for processing.

To achieve the object, there is provided a wafer inspection system for inspecting a wafer, comprising: a platform for receiving the wafer; a probe card including an opening hole and a plurality of probes for contacting the wafer to transmit and receive electrical signals; an illuminator for illuminating on the wafer through the opening hole of the probe card; a test server connected to the illuminator for being controlled to execute test procedure and data process; a load board; at least a relay board connected to the probe card and the load board for switching a direction of data flow; at least an image card corresponding to and connected to the at least a relay board for processing received image signals; at least an image processing device connected to the test server and the at least an image card for receiving and processing image signals from the at least an image card, and sending a test result to the test server; a control circuit board connected to the test server and the load board for receiving commands from the test server and sending control commands through the load board; and at least a test circuit board connected to the load board for sending test signals according to the received control commands, performing a determination on received result signals and sending a determined result to the control circuit board through the load board.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a conventional wafer inspection system;

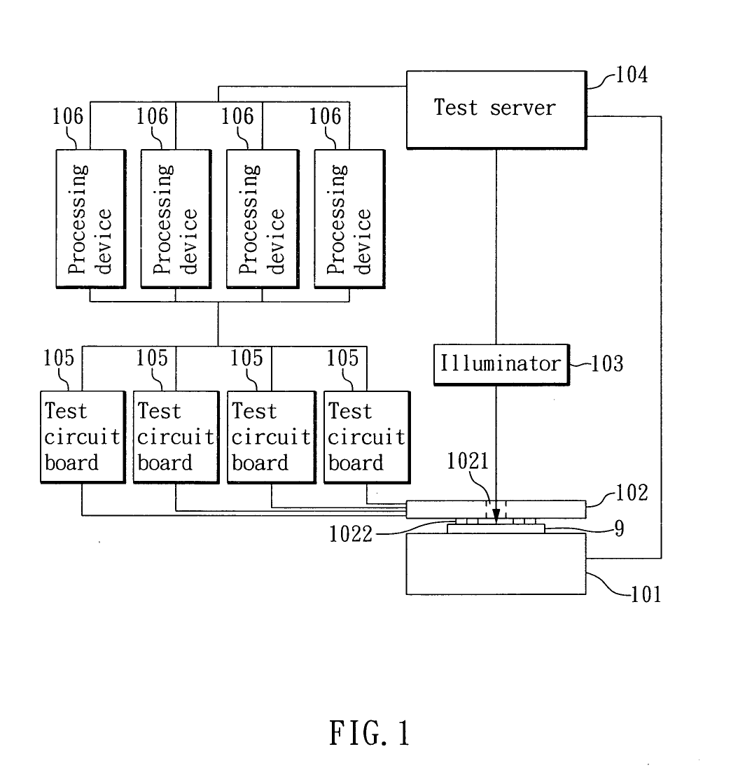

FIG. 2 is a schematic diagram of the wafer inspection system according to an embodiment of the present invention;

FIG. 3 is a schematic diagram of the relay board of the wafer inspection system according to an embodiment of the present invention.

### DETAILED DESCRIPTION OF THE PREFERRED EMBODIMENT

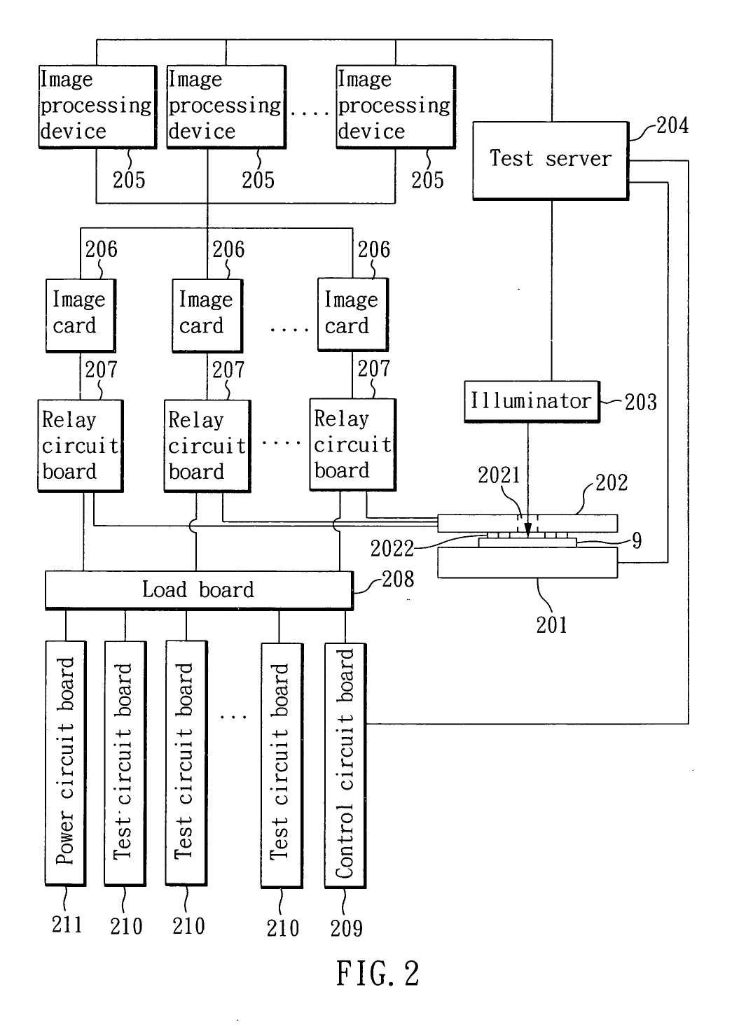

With reference to FIG. 2, FIG. 2 is a schematic diagram of the wafer inspection system according to the present invention. As shown in FIG. 2, the system comprises a platform 201, a probe card 202, an illuminator 203, a test server 204, at least an image processing device 205, at least an image card 206, at least a relay board 207, a load board 208, a control circuit board 209, at least a test circuit board 210 and a power circuit board 211. The platform 201 is connected to the test server 204 preferably through GPIB (General Purpose Interface Bus) interface. The test server 204 is connected to the illuminator 203, the at least an image processing device 205 and the control circuit board 209. The at least an image processing device 205 is connected to the at least an image card 206 preferably through a USB interface. The at least a relay board 207 is connected to the probe card 202 and the load board 208, and respectively connected to the corresponding image card 206. Preferably, the at least a relay board 207 is connected to the corresponding image card 206 and load board 208 through planar cables. The load board 208 is connected to the control circuit board 209, the at least a test circuit board 210 and the power circuit board 211.

The aforementioned platform 201 is used for receiving the wafer 9, which includes a plurality of dies. The probe card 202 includes an opening hole 2021 and a plurality of probes 2022. The probes 2022 are used to directly contact the wafer 9 for transmitting and receiving electrical signals. The illuminator 203 illuminates on the wafer 9 through the opening hole 2021 of the probe card 202. The test server 204 is provided for being controlled to issue commands to execute test procedure and data process, and moving the platform 201 to make one or a plurality of dies under test contact the probes 2022 of the probe card 202. The at least an image processing device 205 is used for receiving image signals from the at least an image card 206, processing and sending the test result to the test server 204. The at least an image card 206 is used for receiving and processing the image signals from the corresponding relay board 207. The at least a relay board 207 is used for switching the direction of data flow. The control circuit board 209 is used for receiving commands from the test server 204 and sending control commands through the load board 208. The at least a test circuit board 210 is a pin electronics card (PE card), which preferably corresponds to the respective relay board 207, for sending test signals according to the received control commands, determining the received result signals and sending result to the control circuit board 209 through the load board 208. The power circuit board 211 is used for providing power.

When inspecting a wafer 9, the wafer 9 is placed on the platform 201, so that the probes 2022 of the probe card 202 are made to directly contact the wafer 9. The test server 204 sends a control command to the control circuit board 209. The control circuit board 209 controls the at least a test circuit board 210 through the load board 208, and the test circuit board 210 sends a test signal. The at least a relay board 207 receives the test signal, and switches to send the received test signal to the probe card 202. The probe card 202 transmits the test signal to the wafer 9 through the probes 2022, receives a response signal from the wafer 9, and sends the response signal to the at least a relay board 207. The at least a relay board 207 receives the response signal, and switches to send the response signal to the corresponding image card 206 or the load board 208, wherein the response signal is sent to the corresponding image card 206 if it is an image capture signal, and sent to the load board 208 if it is an electrical signal related to DC test. The image card 206 processes the received response signal to generate an image signal, and transmits it to the at least an image processing device 205 for processing. The load board 208 sends the received response signal to the at least a test circuit board 210 for performing a determination, and the at least a test circuit board 210 generates a result signal and sends it to the control circuit board 209 for being further sent to the test server 204.

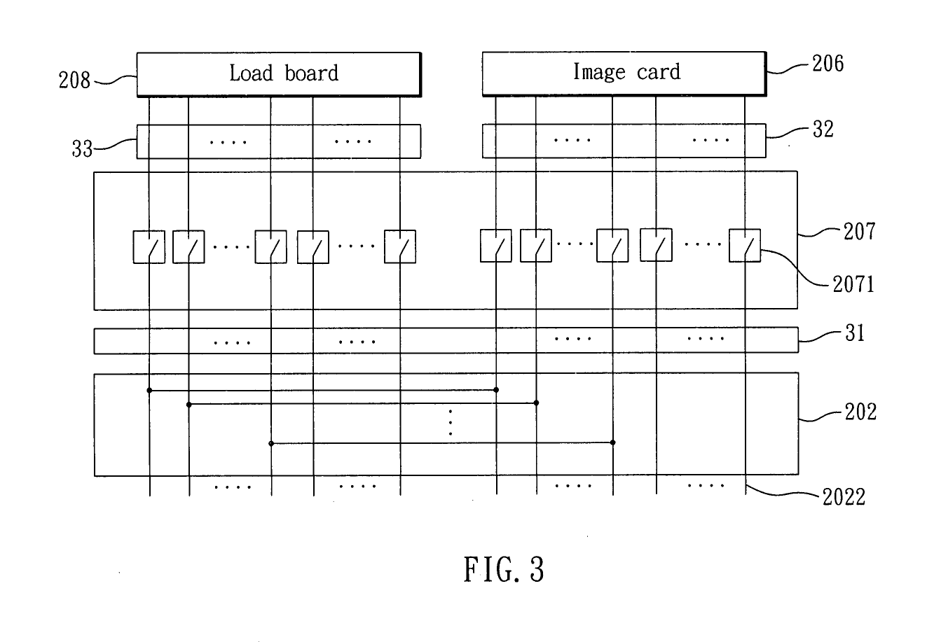

With reference to FIG. 3, FIG. 3 is a schematic diagram of the relay board of the wafer inspection system according to an embodiment of the present invention. As shown in FIG. 3, the relay board 207 is connected to the probe card 202 through the planar cable 31, connected to the image card 206 through the planar cable 32, and connected to the load board 208 through the planar cable 33. The relay board 207 has a plurality of relays 2071, which respectively correspond to the probes 2022 of the probe card 202 and are respectively connected to the probes 2022 through the planar cable 31. Thus, by switching the relays 2071, the relay board 207 can send the received electrical signals or image capture signals to the connected image card 206 or load board 208 for proceeding subsequent data processing procedure.

In the wafer inspection system, the at least a relay board is used for switching the direction of data flow. Thus, all of the test signals and the response signals received from the wafer under test are directly transmitted to targets for subsequent processing. For example, the image capture signals received from the wafer are directly transmitted to the image processing devices through the relay board. Compared with the conventional system, since not all of the signals including the electrical signals and the image capture signals are processed and transmitted by the test server in the wafer inspection system of the present invention, the work efficiency, the signal processing efficiency and the data transmission rate are not limited by the hardware of the test server.

Furthermore, the wafer inspection system of the present invention is very flexible in use. The amount of the test circuit boards, the relay boards, the image cards and the image processing devices can be increased according to the user's demands, thus, the test efficiency can be improved effectively, and the amount of dies inspecting simultaneously can also be increased.

Although the present invention has been explained in relation to its preferred embodiment, it is to be understood that many other possible modifications and variations can be made without departing from the scope of the invention as hereinafter claimed.

What is claimed is:

1. A wafer inspection system for inspecting a wafer, comprising:
a platform for receiving the wafer;
a probe card including an opening hole and a plurality of probes for directly contacting the wafer to transmit and receive electrical signals;
an illuminator for illuminating on the wafer through the opening hole of the probe card;
a test server connected to the illuminator for being controlled to execute test procedure and data process;
a load board;
at least a relay board connected to the probe card and the load board for switching a direction of data flow;
at least an image card respectively corresponding to and connected to the at least a relay board for processing received image signals;
at least an image processing device connected to the test server and the at least an image card for receiving and processing the image signals from the at least an image card, and sending a test result to the test server;
a control circuit board connected to the test server and the load board for receiving commands from the test server and sending control commands through the load board; and
at least a test circuit board connected to the load board for sending test signals according to received control commands, performing a determination on received result signals and sending a determined result to the control circuit board through the load board.

2. The system as claimed in claim 1, wherein the test server sends a control command to the control circuit board, and the control circuit board controls the at least a test circuit board through the load board in order to send a test signal; the at least a relay board switches to send the received test signal to the probe card; the probe card transmits the test signal to the wafer through the probes, receives a response signal from the wafer, and sends the response signal to the at least a relay board; the at least a relay board switches to send the response signal to the at least an image card or the load board.

3. The system as claimed in claim 2, wherein the at least an image card processes the received response signal to generate an image signal, and transmits the image signal to the at least an image processing device for processing.

4. The system as claimed in claim 2, wherein the load board sends the received response signal to the at least a test circuit board for performing a determination, and the at least a test circuit board generates a result signal and sends it to the control circuit board for being further sent to the test server.

5. The system as claimed in claim 2, further comprising a power circuit board connected to the load board for providing power.

6. The system as claimed in claim 1, wherein the at least a relay board includes a plurality of relays, which respectively correspond to the plurality of probes of the probe card.

7. The system as claimed in claim 1, wherein the at least a relay board respectively corresponds to the at least a test circuit board.

8. The system as claimed in claim 2, wherein the wafer has a plurality of dies, and the test server is connected to the platform for being moved, so as to make the plurality of probes of the probe card contact one or a plurality of dies under test.

9. The system as claimed in claim 8, wherein the test server is connected to the platform through GPIB interface.

10. The system as claimed in claim 1, wherein the at least a relay board is connected to the load board through at least a planar cable, and connected to the at least an image card through at least a planar cable.

11. The system as claimed in claim 1, wherein the at least an image card is respectively connected to the at least an image processing device through USB interface.

12. The system as claimed in claim 1, wherein the at least a test circuit board is each a pin electronics card.
